(19) United States
(12) Patent Application Publication
(10) Pub. No.: US 2023/0241531 A1
(43) Pub. Date: Aug. 3, 2023

(54) CLEANING GASES FROM THE DEGASSING OF POLYMER MELTS

(71) Applicant: Baratti GmbH, Belalp (CH)

(72) Inventor: Gerhard BARATTI, Belalp (CH)

(73) Assignee: Baratti GmbH, Belalp (CH)

(21) Appl. No.: 18/011,885

(22) PCT Filed: Jun. 22, 2021
(86) PCT No.: PCT/EP2021/067001

§ 371 Date: Dec. 21, 2022

(30) Foreign Application Priority Data
Jun. 22, 2020 (DE) 10 2020 116 414.9

(51) Int. Cl. B01D 19/00; B01D 5/00; B01D 53/00; B29C 37/00

(52) U.S. Cl. CPC B01D 19/0036; B01D 5/0012; B01D 5/0096; B01D 53/002; B01D 5/009; B01D 5/0072; B01D 5/0051; B29C 37/006; B29B 2013/005

(57) ABSTRACT

A method and a device for the purification of gases from the degassing of polymer melts—in particular, for the continuous further processing to form stretched polymer films. In this case, the gas to be purified is fed from a vacuum zone of a plasticizing unit, via at least one vacuum or degassing line, to a vacuum separator with a gas inlet and a gas outlet in which condensible, separable by freezing, and/or re-sublimable substances are separated from the supplied and purified gas by means of a cooling arrangement, and the separated substances are removed from the vacuum separator. By means of a heating arrangement, the substances separated by means of the cooling arrangement are at least partially liquefied or softened in the vacuum separator and removed from the vacuum separator in particular by suction.

### TECHNICAL FIELD

The invention relates to a method and a device for the purification of gases from the degassing of polymer melts—in particular, for the continuous further processing to form stretched polymer films.

### PRIOR ART

European patent specification EP 1 262 727 B1 describes a device for the suction or pressure conveying of dust or granular material, as is used in plastics processing—in particular, during stretching of polymer films. It is described therein how substances which are disruptive to the further plastic processing are suctioned off as exhaust air in the region of suction or pressure conveying, thereby improving the quality of the plastic processing.

From German patent DE 10 2007 056 610 B4, a method for extruding plastic parts is known, in which sublimable, non-sublimable, and/or condensible gases are removed from the viscous plastic material to be further processed and are cooled in a device by means of a horizontally-cooled plate and separated on the plate, where they are removed from time to time by means of compressed air. This makes it possible to improve the quality of the plastic processing—in particular, by reliably removing disruptive organic substances.

The device known from German patent application DE 10 2013 000 316 A1 for the degassing of polymer melts develops the method known from German patent DE 10 2007 056 610 B4 in that the cooling plates are replaced by several parallel cooling pipes.

Another device of this type for degassing polymer melts is known from Japanese patent application JP H06-190897 A, in which the exhaust gas is efficiently discharged by a vacuum pump. In order to prevent clogging of the vacuum pump lines, the exhaust gas is cooled with liquid water, or the condensed substances are heated and subsequently removed via a removal point. For this purpose, the tank shell is designed as a heat sink and a heating body. Furthermore, a number of plates are arranged in a tank in order to ensure a passage of the gas to be purified in a zigzag shape and thereby improve the efficiency.

A similar device for removing condensible constituents of warm exhaust gas flows which are produced in processes of polymer production is known from German patent disclosure DE 196 53 613 A1. In this case, the gas flow is fed to a drum or rotary pipe drying unit, followed by the combined heat exchanger and separator.

This is a vertical multi-casing pipe. The exhaust gas enters the concentric annular gap between two pipes in order to descend in counterflow with respect to coolant flows which flow in separate pipes. The gas reaches the bottom of the separator in the vicinity of a condensate outlet in order to be returned to a further annular gap before reaching the lower outlet nozzle. The substances condensed in the combined heat exchanger and separator are intermittently removed by replacing coolant with heating medium and thereby heating it to 60° C.-80° C.

The German patent disclosure DE 10 2014 016 380 A1 also discloses a device for degassing polymer melts and neutralizing the resulting exhaust gases. In order to improve the purification of the exhaust gases, a plasma device is used as a precursor stage to the vacuum separation, with condensation of the impurities converted into a plasma state. As a result, the purification effect can be improved.

The method for injection-molding plastic parts known from European Patent EP 2 322 338 B1 describes a further way to improve the method by heating the plastic granulate to a temperature above 100° C. before the disruptive substances are suctioned off. This leads to a more efficient separation of the disruptive substances and the plastic to be further processed, which improves the quality of the method.

### DESCRIPTION OF THE INVENTION

The object of the invention is to specify an improved method, compared to the prior art, or an improved device for the purification of gases from the degassing of polymer melts—in particular, for the continuous further processing to form stretched polymer films.

The object is achieved according to the invention with a method having the features specified in claim 1 and with a device which has the features specified in claim 4.

Advantageous embodiments of the invention are the subject matter of the dependent claims.

The method according to the invention for the purification of gases from the degassing of polymer melts is suitable in particular for processing plastics of polymer melts for continuous production of stretched polymer films. Furthermore, the method is suitable for the purification of gases from the degassing of polymer melts from the compounding of plastics—in particular, of recycled plastics.

The method for the purification of gases from the degassing of polymer melts has the following features. From a vacuum zone of a plasticizing unit, in which plastic granulate is heated and wherein sublimable, non-sublimable, and/or condensible gases are formed and mix with the ambient gas to form a gas to be purified, the gas to be purified is fed, via at least one vacuum or degassing line, to a vacuum separator with a gas inlet and a gas outlet. In the vacuum separator, condensible, separable by freezing, and/or re-sublimable substances are separated from the supplied and to-be-purified gas by means of a cooling arrangement. In addition, the substances separated by means of the cooling arrangement are at least partially liquefied or softened by means of a heating arrangement and removed from the vacuum separator.

The cooling arrangement is preferably operated in such a way that, due to its selected low temperature, a rapid and comprehensive separation in the form of a freezing-out of the disruptive substances out of the gas to be purified is at least substantially achieved. This low temperature is preferably below the triple point of the substances to be separated and thus significantly below the temperature which is achieved or is to be achieved by the heating arrangement on the cooling arrangement for heating the separated substances.

The separation of the substances from the gas to be purified in the vacuum separator by means of the cooling arrangement can thereby take place by freezing-out—in particular, at a temperature in the range of minus 18° C. In particular, the freezing-out has proven particularly effective, since the separation effect is particularly efficient here, and the quantity of separated disruptive substances is regularly significantly above 90%. This is preferably achieved by the fact that the cooling arrangement is cooled down to a temperature in the range of minus 18° C. or below, which is achieved in particular by applying a correspondingly cooled coolant—in particular, a glycol.

This efficiency is ensured to a particular degree when, additionally, a negative pressure of less than 100 mbar—in particular, in the range of or below 10 mbar—is applied in the vacuum separator and in the feed line connected thereto for the gas to be purified with the vacuum zone connected thereto, and, as a result, the undesired substances are degassed very efficiently from the polymer melt, and the resulting considerable gas volume of undesired substances, e.g., water or also olefins or plasticizers, is fed to the vacuum separator and, in the described manner, preferably cooled below the triple point by means of the cooling arrangement, and the undesired substances can thus be frozen out and removed from the vacuum separator after heating by means of the heating arrangement and stripping with the purification device. In this case, the choice of the cooling temperature and the selection of the negative pressure proves to be very advantageous because, on the one hand, efficient, extensive degassing of the plastics to be processed is achieved, and, on the other, an efficient freezing-out of these undesired substances in the gas flow is achieved. This leads to a significant lowering of the gas volume by up to 95% in the device after the freezing-out process, because the considerable gas volumes of the undesirable, still gaseous substances, which are frozen out by means of the method or the device, are removed from the system, and thus the negative pressure is maintained or further reduced without any problem. As a result, it is possible according to the invention for the number of vacuum pumps necessary for the generation of the negative pressure to be reduced, or their power to be considerably reduced. This leads to an extremely energy-favorable device according to the invention or to a correspondingly more efficient method for the purification of gases from the degassing of polymer melts. Moreover, this embodiment also ensures that the quantity of undesirable, not-separated substances can be reduced, and the subsequent components of the device are thus less impacted and soiled, and thus the need for necessary purification or maintenance can be reduced. The service life of these components—in particular, of the vacuum pumps—can also be increased.

By providing the heating of the separated substances, which in particular contain hydrocarbons of different chain length and structure, in the vacuum separator by means of the heating arrangement, it is possible to enable an efficient separation process in the vacuum separator. By heating, which regularly leads to an at least partial liquefying or softening of the separated substances, it is, advantageously, possible to remove the separated substances from the cooling arrangement in a simple and efficient manner and thereby to achieve an efficient cooling of the gas to be purified, and thus a separation of the disruptive substances in the gas to be purified.

Furthermore, it has proven to be particularly advantageous to provide the device for the purification of gases with a mechanical purifying device—in particular, with at least one scraper for the at least partial surface scraping of the separated substances from the cooling arrangement. As a result of the interaction of the heating arrangement with the mechanical purifying device, the at least partially liquefied and/or softened separated substances can be detached particularly easily and efficiently, so that these detached, separated substances fall downwards due to their weight into the lower region of the vacuum separator provided with the removal opening and can be removed there in a simple manner by means of the removal opening. In this case, the mechanical purifying device is adapted to the cooling arrangement in such a way that it can scrape off the surface of the cooling arrangement and thereby detach—in particular, scrape off or abrade—frozen-out substances located thereon. Preferably, the mechanical purification does not take place continuously during the entire process of purifying gases from the degassing of polymer melts, but only during portions of the entire process of purifying gases from the degassing of polymer melts—in particular, during or after the heating process. In this case, the vacuum separator is preferably designed such that it has a closed housing which has a gas inlet for feeding the gas to be purified and a gas outlet for discharging the gas purified in the vacuum separator. In the interior of the housing, a cooling arrangement for cooling the gas to be purified is arranged, by means of which disruptive substances, such as sublimable, non-sublimable, and/or condensible gases from the degassing of polymer melts are separated. These separated substances can be condensed, frozen out, and/or re-sublimated.

The disruptive substances are usually cooled in such a way that a viscous, plastic, or solid phase is formed, which makes further separation of disruptive substances more difficult due to a reduced heat transfer between the gas to be purified and the cooling arrangement. To improve efficiency, it has proven advantageous to heat, and thereby at least partially liquefy or soften, and then preferably mechanically remove the separated substances.

In this case, the cooling arrangement can contain one or more cooling elements which can be designed to be different. Cooling elements in the form of plate or pipe coolers, which can be arranged inside the housing of the vacuum separator or on or in the wall of the vacuum separator, have proven particularly effective. In this case, the cooling effect can be generated by applying cooling medium (gaseous or liquid) to the cooling elements, but also by electrical, physical, or chemical processes in or on the cooling elements.

The separated substances which contain in particular hydrocarbons of different chain length and structure typically have different solidification temperatures or liquefaction temperatures or softening temperatures, so that the separated phase of the separated substances on the cooling arrangement is softened or liquefied over a wide temperature range by heating. Even when a partial softening or liquefaction of the separated phase is reached, it is possible to remove the separated, disruptive substances efficiently with little effort and with little risk of damage to the cooling arrangement from the cooling arrangement, and to remove them from the vacuum separator.

Regardless of the provision of heating by means of a heating arrangement, which at least partially liquefies or softens the substances separated by means of the cooling arrangement, a method for the purification of gases from the degassing of polymer melts has proven to be particularly efficient for the plastics processing of polymer melts for continuous production of stretched polymer films. This method for the purification of gases from the degassing of polymer melts from the compounding of plastics is suitable in particular for recycling plastics.

The method for the purification of gases from the degassing of polymer melts has the following features. From a vacuum zone of a plasticizing unit, in which plastic granulate is heated and wherein sublimable, non-sublimable, and/or condensible gases are formed and mix with the ambient gas to form a gas to be purified, the gas to be purified is fed, via at least one vacuum or degassing line, to a vacuum separator with a gas inlet and a gas outlet. In the vacuum separator, condensible, separable by freezing, and/or re-sublimable substances are separated from the supplied gas to be purified by means of a cooling arrangement. In addition, the substances separated by means of the cooling arrangement are at least partially scraped off from the cooling arrangement by means of a purifying device and removed from the vacuum separator. The separation of the substances from the gas to be purified in the vacuum separator by means of the cooling arrangement, in addition to the condensation or re-sublimation, can also take place by freezing-out—in particular, at a temperature in the range of minus 18° C. In particular, the freezing-out has proven particularly effective, since the separation effect is particularly efficient here, and the proportion of separated disruptive substances is regularly significantly above 90%, thereby enabling particularly efficient purification of the gases, even without heating the separated substances by means of a heating arrangement. This is preferably achieved in that the cooling arrangement is cooled to a temperature in the range of minus 18° C. or below, which is achieved in particular by applying a correspondingly cooled coolant.

According to a further development of the invention, the heating arrangement can contain one or more heating elements which can be designed to be different. Heating elements in the form of plate or pipe heating elements, which can be arranged inside the housing of the vacuum separator or on or in the wall of the vacuum separator, have proven particularly effective. In this case, the heating effect can be generated by applying heating medium (gaseous or liquid) to the heating elements, but also by electrical, physical, or chemical processes in or on the heating elements.

The removal of the liquefied or softened disruptive substances proves to be substantially simpler than in the prior art, in which the frozen-out, solid disruptive substances are scraped from the cooling arrangement and removed through a large maintenance opening after sweeping them together. The removal of the liquefied or softened disruptive substances can preferably take place by suction via a preferably small suction opening. This makes it possible to fill the interior of the vacuum separator substantially with a cooling arrangement or a heating arrangement and thereby to select the cooling or heating surface to be particularly large, which enables a particularly efficient process control.

In addition, it has proven particularly advantageous to further develop the method for the purification of gases from the degassing of polymer melts such that the substances separated by means of the cooling arrangement are heated to a temperature in the range of the liquefaction temperature or softening temperature of at least one part of the separated substances. In this case, the heating is selected in particular such that a temperature in the range of 100° C. or above, and in particular in the range of 160° C., is achieved.

As a result, it is possible to very efficiently remove at least a substantial part of the disruptive substances from the gas to be purified by separation and subsequent removal on or from the cooling arrangement and thereby create a very effective device for the purification of gases from the degassing of polymer melts. This makes it possible to remove the disruptive substances to a sufficient extent from the immediate plastic processing process and to make the purification process safe and efficient. This development is characterized in particular in that the quantity of the disruptive substances which leave the vacuum separator and are drawn in through the subsequently arranged vacuum system has to be limited to a low mass, and, as a result, subsequent components of the device for the purification of gases from the degassing of polymer melts must be protected against damage.

Furthermore, it has proven particularly useful to further develop the method for the purification of gases such that the cooling arrangement and the heating arrangement have common cooling and heating elements. It proves particularly advantageous if substantial parts or all of the cooling and heating elements are designed as common cooling and heating elements. This makes it possible to very efficiently use the interior and/or the wall of the vacuum separator for the cooling arrangement or for the heating arrangement, with their common heating and cooling elements. This is made possible in particular by reducing the space requirement for the heating arrangement and cooling arrangement without limiting the heating or cooling performance, which is associated with a particularly advantageous utilization of space of the vacuum separator.

Preferably, in particular the common cooling and heating elements are alternately supplied with a heating or cooling medium, thereby ensuring the alternating function of heating and cooling, which enables a particularly efficient process control. This is particularly true when the selected heating and cooling medium are identical. Oils or water or mixtures thereof have proven to be particularly advantageous as heating and cooling media.

It has proven particularly useful to further develop the method for the purification of gases from the degassing of polymer melts in such a way that the separation and the liquefaction of the condensed, frozen out, and/or re-sublimated substances from the supplied gas to be purified are effected in alternation with the removal of the separated substances. This sequential execution of the individual method steps of separation and liquefaction or softening ensures that these steps can take place very efficiently, without any negative influence. The removal takes place regularly after the liquefying or softening, which simplifies the process control. It is also possible for a temporal overlap between liquefying or softening and removal—in particular, by suction—to take place and thereby to reduce the time in which the vacuum separator is not available for the separation of disruptive substances. After removal, the process step of separation followed by liquefying or softening, etc., is continued.

A particularly preferred embodiment of the invention provides a device for the purification of gases from the degassing of polymer melts, wherein the gas to be purified is supplied from a vacuum zone of a plasticizing unit by means of at least one vacuum or degassing line to the device, with a vacuum separator which has a housing which has a gas inlet for the gas to be purified and a gas outlet which has a cooling arrangement by means of which condensible, separable by freezing, and/or re-sublimable substances can be separated from the supplied gas to be purified, and from which the separated substances can be removed from the housing of the vacuum separator. In this case, the vacuum separator is provided with a heating arrangement which is suitable for at least partially liquefying or softening substances separated by means of the cooling arrangement. The at least partially softened or liquefied substances can subsequently be removed from the vacuum separator in a particularly simple manner.

By providing the heating of the separated substances, which in particular contain hydrocarbons of different chain length and structure, in the vacuum separator by means of the heating arrangement, it is possible to enable an efficient separation process in the vacuum separator. As a result of the heating, which normally leads to an at least partial liquefying or softening of the separated substances, it is, advantageously, possible to remove the separated substances from the cooling arrangement in a simple and efficient manner, which normally takes place by draining or dripping from the cooling arrangement. As a result, the cooling effect of the cooling arrangement is improved, and thus an efficient cooling of the gas to be purified and thus a particularly effective separation of the disruptive substances in the gas to be purified is achieved.

It has proven particularly useful to further develop the device for the purification of gases from the degassing of polymer melts such that a removal opening is provided in the lower region of the housing of the vacuum separator, by means of which the separated and at least partially liquefied or softened substances can be removed. As a result of the liquefying or softening, the separated substances can be removed from the cooling arrangement in a simple manner, which is brought about by mechanical, chemical, or physical aids—in particular, by the action of the weight of the materials—and this causes the substances to collect in the region of the lowest point of the interior of the vacuum separator, where a removal opening is preferably arranged. This enables, in particular, the suction of the at least partially liquefied or softened substances which have originally separated on the cooling arrangement and have been liquefied or softened by heating by means of the heating arrangement and have thus detached from the cooling arrangement.

It is particularly advantageous to provide a suction opening which can be of significantly smaller diameter than a conventional removal opening of a vacuum separator from the prior art, which makes it possible to introduce tools and, if necessary, to allow an access by the operator of the device for sweeping and removing the collected solid materials. An inner diameter of a few cm, and in particular in the range of 5 cm, is sufficient.

In this case, the heating arrangement can contain one or more heating elements which can be designed to be different. Heating elements in the form of plate or pipe heating elements, which can be arranged inside the housing of the vacuum separator or on or in the wall of the vacuum separator, have proven particularly effective. In this case, the heating effect can be generated by applying heating medium (gaseous or liquid) to the heating elements, but also by electrical, physical, or chemical processes in or on the heating elements.

The cooling arrangement can also contain one or more cooling elements which can be designed to be different. Cooling elements in the form of plate or pipe coolers, which can be arranged inside the housing of the vacuum separator or on or in the wall of the vacuum separator, have proven particularly effective. In this case, the cooling effect can be generated by applying cooling medium (gaseous or liquid) to the cooling elements, but also by electrical, physical, or chemical processes in or on the cooling elements.

The vacuum separator has a housing which has a gas inlet for the gas to be purified and a gas outlet. The gas inlet is arranged below the gas outlet in the housing, as a result of which an upward gas flow of the gas to be purified is produced in the interior of the housing and flows along the cooling arrangement. Preferably, the gas inlet is arranged in such a way that the gas to be purified, which flows into the interior of the housing, impinges in a targeted manner on the cooling arrangement in the region of the lower end and is subsequently guided upwards along the cooling arrangement in the direction of the gas outlet. This preferred embodiment makes it possible to achieve an efficient cooling of the gas to be purified with the aid of the cooling arrangement.

A preferred development of the device for the purification of gases has a cooling arrangement which is designed to cool the gas to be purified—in particular, to a temperature in the range of minus 18° C. or below—in such a way that the freezable substances can be separated by freezing-out from the supplied gas to be purified. In particular, the freezing-out has proven particularly effective, since the separation effect is particularly efficient here, and the quantity of separated disruptive substances is regularly significantly above 90%. This is preferably achieved in that the cooling arrangement is cooled to a temperature in the range of minus 18° C. or below, which is achieved in particular by applying a correspondingly cooled coolant.

In addition to the particularly advantageous combination of the described embodiment of the cooling arrangement with the described embodiment of the heating arrangement, which is suitable for at least partially liquefying or softening substances separated by means of the cooling arrangement, it has also proven to be very advantageous in a device for the purification of gases with a heating arrangement to design this device for the purification of gases without such a heating arrangement. The cooling arrangement is designed such that the gas to be purified is cooled—in particular, can be cooled to a temperature in the range of minus 18° C. or below—in such a way that the freezable substances can be separated by freezing-out from the supplied gas to be purified. In particular, the freezing-out at a negative pressure in the range of 10 mbar or below 10 mbar has proven particularly effective, since the separation effect is particularly efficient here, and the proportion of disruptive separated substances is normally significantly above 90%, and the gas volume in the device can be reduced by up to 95% by freezing-out. This is preferably achieved in that the cooling arrangement is cooled to a temperature in the range of minus 18° C. or below, which is achieved in particular by applying a correspondingly cooled coolant. Preferably, by means of a purifying device, the frozen-out substances separated by means of the cooling arrangement are at least partially scraped off from the cooling arrangement and removed from the vacuum separator. This design of the device for the purification of gases proves to be very effective even without a heating arrangement for heating the separated substances. In particular, this makes it possible to design a smaller, associated vacuum arrangement for producing the gas flow from the vacuum zone through the vacuum separator and, if necessary, to dispense with subsequent filter stages.

A preferred development of the device for the purification of gases has a heating arrangement which is designed to heat the substances separated by means of the cooling arrangement to a temperature in the range of the liquefaction or softening temperature of at least part of the separated substances, wherein the heating is in particular performed to a temperature in the range of 100° C. or above, and in particular in the range of 160° C. This further development is characterized by good liquefaction of the essential disruptive substances, so that the dripping of the separated—in particular, frozen-out—disruptive substances from the cooling arrangement is very effective, and the typically later removal can take place very easily and reliably.

According to a preferred development of the device for the purification of gases, the heating arrangement has a heating gas feed, by means of which heating gas can be supplied to the housing in such a way that the supplied heating gas impinges on the cooling arrangement and is able to at least partially heat and liquefy substances separated thereon. The at least partially liquefied or softened substances can thus be removed from the housing of the vacuum separator via the removal opening. This is all the more true when the at least partially liquefied or softened substances already detach from the cooling arrangement due to their weight and pass downwards into the lower region of the interior, and thus into the region of the removal opening. In this case, the detaching process can be controlled by suitable temperature selection and can optionally be supported by mechanical processes (e.g., by use of mechanical purifying devices) and/or by other physical-chemical processes (e.g., by using suitable solvents or cleaning means).

Preferably, the heating gas is selected as at least one inert gas, as steam, as water vapor, or as a combination of several components thereof. This choice enables very efficient and safe heating.

In this case, the heating gas, which is preferably an inert gas such as, for example, nitrogen, is introduced into the interior of the vacuum separator in such a way that the temperature-controlled heating gas is applied to the entire cooling arrangement and thus can effect its heating on the entire cooling arrangement with the disruptive substances separated thereon. In addition to a separate heating gas feed and heating gas discharge, it has proven particularly useful to use the existing gas inlet and the existing gas outlet for feeding and discharging the heating gas, wherein the alternative feeding or removal of heating gas or gas to be purified is made possible by means of upstream and downstream valves.

According to a particularly preferred embodiment of the device, the heating arrangement has at least one heating pipe which extends into the interior of the housing of the vacuum separator and is designed in particular as a double-walled heating pipe for receiving a heating medium. In particular, several heating pipes and/or inner and outer pipes of one or more double-walled heating pipes are interconnected in a meandering manner. It has proven particularly useful to use a gaseous or liquid heating medium. Liquid heating media such as water—in particular, distilled water or oils, such as, for example, thermal oils or silicone oils—have proven particularly effective. These enable very efficient heat transfer due to their thermal capacity. The preferred provision of meandering heating pipes or providing a plurality of pipes makes it possible to achieve very effective heating of the separated substances on the cooling arrangement. This is particularly achieved in that heating pipes are arranged adjacent to the cooling arrangement, and in particular to the cooling pipes thereof. The cooling and heating pipes are preferably arranged substantially in parallel to one another.

In a particularly preferred embodiment of the device for the purification of gases, the housing of the vacuum separator has a cover which forms a feed and/or discharge line to several—in particular, parallel-running—heating pipes and/or heating pipes designed as double-walled pipes. As a result, it is possible to realize a very compact vacuum separator which is characterized by an efficient cooling and also by an efficient heating, whereby a particularly good purifying effect for the gases can be achieved.

Furthermore, it has proven to be particularly advantageous to design the device for the purification of gases such that the heating arrangement is arranged at least partially in the wall of the housing. In this case, at least one heating pipe extending in the wall of the housing and/or at least one or more heating pipes connected to one another in a meandering manner and/or one or more interstices extending flatly over the wall of the housing are provided for receiving a heating medium. In this case, the interstices in the wall can have different shapes, e.g., flat pockets in which the heating medium flows into and out, as a result of which the heat of the heating medium in the recess is transmitted to the wall and then reaches the interior with the cooling arrangement for heating the separated substances. The alternative or supplementary provision of heating pipes or interstices for heating in the wall of the housing of the vacuum separator makes it possible to achieve a particularly efficient heating, whereby a particularly good purifying effect for the gases can be achieved.

In this case, the heating pipes and/or interstices for the heating medium or the coolant are spaced apart from one another such that the gases separated on the cooling arrangement can reach a thickness of up to 20 mm without the gas flow of the gas to be purified being significantly restricted. Preferably, therefore, a distance between the heating pipes and/or interstices for the heating medium or the coolant is preferably selected to be above 40 mm.

In a preferred development of the device for the purification of gases, the cooling arrangement and the heating arrangement of the vacuum separator are formed with at least one common pipe and/or at least one common interstice for receiving a heating and cooling medium. In this case, at least one switching valve is preferably arranged upstream and downstream of the at least one common pipe and/or interstice, so that a selective application of heating medium or coolant to the common pipes and/or interstices is possible. Preferably, the pipes or the interstices of the cooling arrangement and the heating arrangement are substantially or completely designed as common pipes or interstices for applying heating medium or coolant. This makes it possible to create a space-saving arrangement of the cooling arrangement and heating arrangement, which enables safe operation, simple production, and very effective purification of gases.

Furthermore, it has also been found to be advantageous to design the device for the purification of gases such that the vacuum separator has a solvent feed by means of which a solvent for the separated substances can be fed to the housing in such a way that solvent supplied impinges on the cooling arrangement and is suitable for at least partially dissolving substances separated thereon, in addition to the heating and the associated, at least partial, liquefying or softening. The at least partially dissolved substances from the housing of the vacuum separator can in particular be removed from the housing of the vacuum separator in a particularly simple manner via the removal opening, in conjunction with the liquefaction or softening process. As a result, this device can be rendered functional again in a particularly fast way for the purification process, viz., the separation of the disruptive substances from the gas to be purified. Preferably, the solvent is introduced in a finely distributed manner into the interior of the vacuum separator via the solvent feed in the manner of an aerosol, so that the solvent is distributed with its many droplets over the substances separated on the cooling arrangement and enables a particularly effective dissolving process—in particular, in conjunction with the effect of the heating arrangement. This is preferably done by means of a nozzle-shaped solvent feed, which opens in particular into the gas inlet and/or into the feed of the heating gas.

Preferably, water, steam, at least one organic solvent, or as a combination of several components thereof are selected as solvent. This choice enables a very efficient and safe softening or liquefying of the separated, and in particular frozen-out, disruptive substances.

It has proven particularly effective to form the mechanical purifying device, and in particular its scrapers, as part of the heating arrangement, and thus to control the temperature such that the separated substances are heated under the effect of the mechanical purifying device, and, as a result, the separated substances can be particularly easily detached or scraped off.

In addition, it has proven effective to additionally apply solvent to the mechanical purifying device, and thereby to further facilitate the detachment or the scraping of the separated substances.

In this case, it has proven to be particularly advantageous to provide the mechanical purifying device with at least one scraper which is oriented obliquely to a vertical of the vacuum separator and cleans the surface of the cooling arrangement with the substances separated thereon by means of a displacement, and scrapes them off. As a result of the oblique orientation, it is possible, on the one hand, to make the scraping of the separated substances very effective and, on the other, to allow the separated, detached substances to fall downwards into the lower region of the interior of the vacuum separator or to facilitate the detachment of the separated substances in the event of adhesion to the scraper—in particular, in case of further action by the heating arrangement.

It has proven particularly useful to further develop the device for the purification of gases in such a way that at least one auxiliary filter arranged in the gas flow is provided which is suitable for filtering out non-separated substances in the gas to be purified. This makes it possible to further improve the purifying result—in particular, when the auxiliary filter is designed to filter out disruptive substances other than those the vacuum separator can remove from the gas to be purified by means of separation and removal. This is achieved in particular by using a special micro- or ultra-fine filter, which can be designed, for example, as a needle felt filter or as a mechanical metal filter with a preferred mesh width in the range of 2 to 10 μm.

According to a preferred development of the device for the purification of gases, several vacuum separators are provided, to which at least one switching valve is connected upstream and downstream. With the switching valves, it is possible for the gas to be purified to be supplied via a central vacuum or degassing line, selectively diverted via the upstream switching valve to a vacuum separator, purified through this vacuum separator, and subsequently guided via a downstream switching valve to a central discharge line for the purified gas, and thus in particular to a vacuum arrangement. In this case, the vacuum arrangement regularly generates a negative pressure which draws the gas to be purified from a vacuum zone of a plasticizing unit upstream of the device through at least one vacuum separator, and thus moves it through the device for purifying the gas.

In particular, at least one further auxiliary filter is subsequently assigned to the vacuum separators, so that an alternative operation of individual vacuum separators and/or auxiliary filters is made possible. Preferably, units are formed from a vacuum separator and a downstream auxiliary filter, and these are formed multiple times in parallel to one another, wherein a switching valve is connected in particular upstream and downstream of this arrangement. Alternatively, this switching valve can also be replaced by several individual valves, and in particular shut-off valves.

As a result, it is possible, while a part of the overall device is in a phase of purification and separation of disruptive substances from the gas to be purified, that another part of the device is in a phase of maintenance, viz., the removal of the separated substances or the readiness, and therefore is not in a phase of purifying and separating disruptive substances from the gas to be purified. With the aid of the switching valves, the function of the different parts of the entire device can be chosen selectively. A continuous purification process of the supplied gas to be purified is thus made possible in a simple manner, and a particularly efficient purification of the supplied gas to be purified and thus an efficient operation of the plastic purification process is made possible.

It has also proven particularly useful to provide the device for the purification of gases with a controller, which is provided with several sensors for detecting operating parameters of the device—in particular, the temperature, the pressure, the time, the volume, or the mass—and with several actuators for controlling the device—in particular, for controlling the gas flow, the heating arrangement, the cooling arrangement, the vacuum arrangement, and/or the purifying arrangement. In addition to several decentralized control units, it has proven particularly useful to provide a single central controller, with which the different states of the device can be controlled, and the sequence—in particular, the start-up or the shutdown of the entire device or also individual parts of the device—can be controlled. This makes it possible to enable an efficient operation of the device and an effective execution of the method for the purification of gases from the degassing of polymer melts—in particular, for the continuous further processing to form stretched polymer films.

The invention is explained by way of example below on the basis of a preferred exemplary embodiment with reference to the figures. The invention is not limited to this preferred exemplary embodiment.

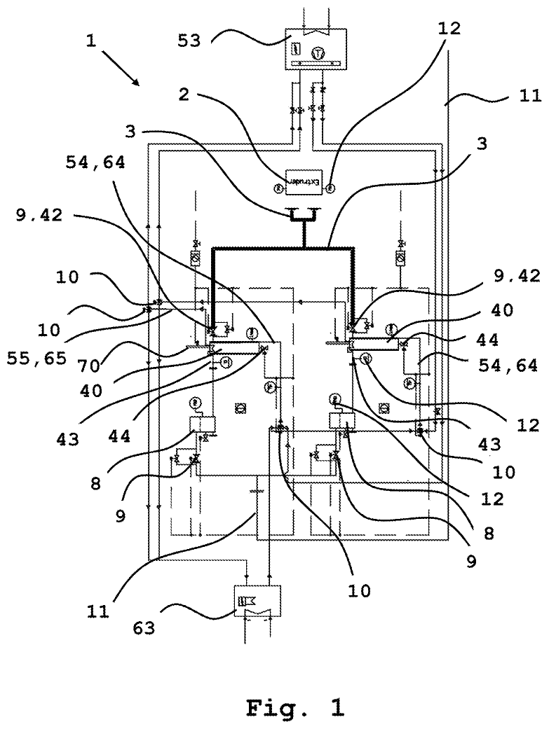

FIG. 1 shows a schematic representation of an R+I diagram of an exemplary device for the purification of gases, and

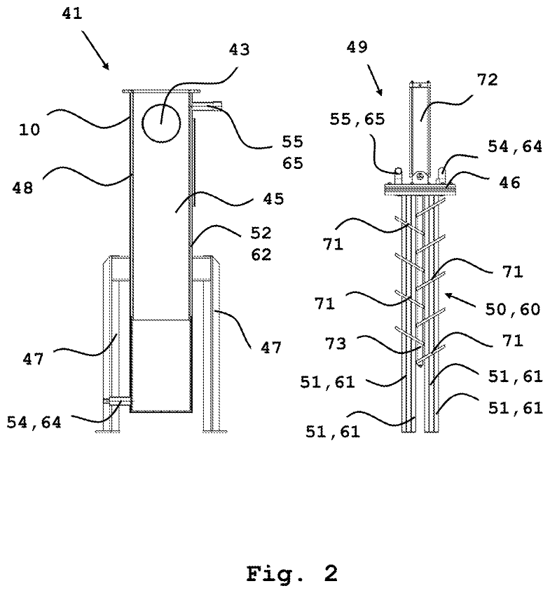

FIG. 2 shows a schematic representation of the structure of a preferred vacuum separator.

FIG. 1 schematically shows an R+I diagram of an exemplary device 1 for the purification of gases.

The device 1 for the purification of gases from the degassing of polymer melts has a schematically illustrated vacuum zone 2, which is assigned to a plasticizing unit, by means of which a plastic granulate is softened, so that it can be fed to further processing in the context of a production process, and in particular a plastic stretching process. The heating results in the generation of substances which are discharged from the plastic granulate into the surrounding gaseous atmosphere and which are disruptive to the further plastics processing process. The gaseous atmosphere thus presents a gas which is mixed with disruptive substances.

The vacuum zone 2 is connected to the device 1 by means of at least one vacuum or degassing line 3 and thus enables the gas to be purified to be supplied from the vacuum zone 2 to the device 1 for the purification of gases.

The vacuum or degassing line 3 divides into two partial lines 3, which open into two vacuum separators 40 via gas inlets 42. Furthermore, these are provided with gas outlets 43, via which the gas exits from the vacuum separators 40 and is guided to downstream auxiliary filters 8, in which the gas is purified once again after a first purification in the vacuum separators 40, which form a first purifying stage. The auxiliary filters 8 form a purifying stage.

The gas to be purified is drawn in through the device 1 by means of a vacuum arrangement, not shown, from the vacuum zone 2 via the vacuum and degassing line 3, via the first purification stage, which is formed by the vacuum separator 40, via the second purification stage, which is formed by the auxiliary filter 8.

In the region of the gas inlets 42, a valve 9 is arranged in each case, which is connected upstream of the vacuum separators 40 which are downstream in the gas flow, and which valve can block or release the gas flow of the gas to be purified into the subsequent vacuum separator 40. The two valves 9 enable the function of a switching valve 9. The two valves 9 thus enable an alternating application of the two vacuum separators 40.

A valve 9 is arranged downstream of the two auxiliary filters 8 in each case in the gas flow, which valve is thus also connected downstream of the vacuum separators 40, which are upstream in the gas flow, and which valve can block or release the gas flow of the purified gas from the upstream auxiliary filter 8. The two valves 9 enable the function of a switching valve 9. The two valves 9 thus enable an alternative discharge of the purified gas from the auxiliary filters 8 arranged in parallel.

The gas flow downstream of the two valves 9 positioned downstream of the auxiliary filters 8 is brought together via a common central discharge line 11 of purified gas and is conveyed in the direction of the vacuum arrangement.

In this case, the vacuum separators 40 are designed such that each has a cooling arrangement 50, by means of which disruptive, condensible, separable by freezing, and/or re-sublimable substances can be separated from the supplied gas to be purified.

The disruptive substances from the gas to be purified are preferably separated in such a way that the disruptive substances are frozen out into ice in the form of an ice layer on the cooling arrangement 50. For this purpose, the cooling arrangement 50 is in particular cooled to a temperature in the range of minus 18° C. or below.

In addition, each vacuum separator 40 is provided with a heating arrangement 60 which is suitable for at least partially liquefying or softening substances separated by means of the cooling arrangement 50. The at least partially softened or liquefied substances can subsequently be removed from the vacuum separator 40 via a removal opening 44 in a particularly simple manner.

The liquefying of the frozen-out disruptive substances from the gas to be purified preferably takes place in such a way that the disruptive substances frozen out to form an ice layer are liquefied by means of the heating arrangement 60. For this purpose, the heating arrangement 60 is subjected to a heating medium, which in particular is heated to a temperature in the range of 160° C.

By providing the heating of the separated substances, which in particular contain hydrocarbons of different chain length and structure, in the vacuum separator 40, by means of the heating arrangement 60, it is possible to enable an efficient separation process in the vacuum separator 40. By heating, which normally leads to an at least partial liquefying or softening of the separated substances, it is, advantageously, possible to remove the separated substances from the cooling arrangement 50 in a simple and efficient manner, which normally takes place by draining or dripping from the cooling arrangement 50. As a result, the cooling effect of the cooling arrangement 50 is improved, and thus an efficient cooling of the gas to be purified and thus a particularly effective separation of the disruptive substances in the gas to be purified is achieved.

In this case, a removal opening 44 is provided in the lower region of the housing 41 of the vacuum separator 40, by means of which removal opening the separated and at least partially to be liquefied or softened substances can be removed.

As a result of the liquefying or softening, the separated substances can be removed from the cooling arrangement 50 in a simple manner, which is brought about by mechanical, chemical, or physical aids—in particular, by the action of the weight of the substances—and causes the substances to collect in the region of the lowest point of the interior 45 of the vacuum separator 40, where a removal opening 44 is arranged. This makes it possible to suction the at least partially liquefied or softened substances, which have originally been separated on the cooling arrangement 50 and have been liquefied or softened by heating by means of the heating arrangement 60, and thus have detached from the cooling arrangement 50.

It is particularly advantageous to provide a suction opening as a removal opening 44, which is of significantly smaller diameter than a conventional removal opening of a vacuum separator in the prior art, which is intended to enable the introduction of tools and, if appropriate, the intervention of the operator of the device for collecting and removing the collected solid materials. An inner diameter of a few cm, and in particular in the range of 5 cm, is sufficient.

Each vacuum separator 40 has a cooling arrangement 50 which is connected to a common cooling unit 53. The coolant is conducted from the cooling unit 53 via coolant lines to the cooling arrangements 50 and is thereby fed via the feed 54 for coolant to the vacuum separator 40 with the cooling arrangement 50. A valve 10 is connected upstream of the feed 54 for coolant and can block or release the coolant flow into the subsequent vacuum separator 40. In a corresponding manner, after leaving the cooling arrangement 50, the coolant is discharged from the vacuum separator 40 via a discharge line 55 for coolant and is returned via a valve 10 in a coolant line to the cooling unit 53. In this case, the coolant flow from the upstream vacuum separator 40 to the cooling unit 53 can be blocked or released by the valve 10. The two valves 10 enable the function of a switching valve 10 for the coolant.

Each vacuum separator 40 additionally has a heating arrangement 60, which is connected to a common heating unit 63. The heating medium is guided from the heating unit 63 via heating medium lines to the heating arrangements 60 and is thereby fed via the feed 64 for heating medium to the vacuum separator 40 with the heating arrangement 60. The feed 64 for heating medium is preceded by a valve 10, which can block or release the heating medium flow into the subsequent vacuum separator 40. In a corresponding manner, after leaving the heating arrangement 60, the heating medium is discharged from the vacuum separator 40 via a discharge line 65 for heating medium and returned to the heating unit 63 via a valve 10 in a heating medium line. In this case, the heating medium flow from the upstream vacuum separator 40 to the heating unit 63 can be blocked or released by the valve 10. The two valves 10 enable the function of a switching valve 10 for the heating medium.

In this case, the valves 10 are designed and arranged such that, in alternation, either heating medium or coolant can be supplied to the cooling arrangements 50 or heating arrangements 60 arranged in the vacuum separators 40, which cooling arrangements are designed as common arrangements 50, 60.

The device 1 for the purification of gases is provided with a central controller, which is provided with several sensors 12 for detecting operating parameters of the device 1—in particular, the temperature, the pressure, the time, the volume, or the mass—and with several actuators 9, 10, 53, 63 for controlling the device 1—in particular, for controlling the gas flow, the heating arrangement 60, the cooling arrangement 50, the vacuum arrangement, and/or the purifying arrangement 70.

In FIG. 1, various sensors are symbolically shown as a circle with an inscription. For example, in the region of the vacuum zone 2, a pressure sensor 12 is shown, with which the pressure of the gas to be purified upstream of the vacuum and degassing line 3 is measured. A further pressure sensor 12 is arranged in the region of the gas outlet 43, and thus in the gas flow downstream of the vacuum separator 40, and can thus measure the pressure of the gas purified by the vacuum separator 40 as the first purification stage. It is thus also possible, in conjunction with the information of the pressure sensor 12 arranged in the region of the vacuum zone 2, to determine the pressure drop between the sensors 12 and to deduce therefrom the degree of separation of the disruptive substances in the vacuum separator 40 through which the flow passes and, depending upon this degree, to stop the cooling process in this vacuum separator 40, to start the heating process with the mechanical scraping of the separated substances on the cooling arrangement 50, and to enable removal via the removal opening 44 or to switch removal to the corresponding vacuum separator 40 with the aid of the switching valves 9 on the parallel branch. A further pressure sensor 12 is thus arranged in the region of the auxiliary filter 8 and thus in the gas flow downstream of the vacuum separator 40, such that it can measure the pressure at the output of the auxiliary filter 8. It is thus also possible, in conjunction with the information of the pressure sensor 12 arranged in the region of the gas outlet 43, to determine the pressure drop between these sensors 12 and to deduce therefrom the degree of separation of the disruptive substances in the auxiliary filter 8 through which the flow passes and, if necessary, to switch, with the aid of the switching valves 9, to the parallel branch with the corresponding vacuum separator 40 with auxiliary filter 8. It is thus possible to clean the auxiliary filter 8 with the extensively separated substances without having to interrupt the method of purifying gases from the degassing of polymer melts.

With the aid of the single central controller, various states of the device 1 can be controlled, and the sequence—in particular, the start-up or the shutdown of the entire device 1 or also individual parts of the device 1—can be influenced. This makes it possible to enable an efficient operation of the device 1 for the purification of gases and an effective execution of the method for the purification of gases from the degassing of polymer melts, and in particular for the continuous further processing to form stretched polymer films.

FIG. 2 shows a schematic representation of a preferred vacuum separator 40. The two parts of the vacuum separator 40 shown are a housing 41 of the vacuum separator 40 and an insert 49 in the housing 41 of the vacuum separator 40.

The housing 41 has a gas outlet 43 in the upper region and a gas inlet 42, not shown, via which the gas to be purified is fed to the vacuum separator 40 and discharged therefrom in the lower region. The gas inlet 42 and the gas outlet 43 have a large diameter, so that the gas to be purified experiences only a low flow resistance.

The wall 48 of the housing 41 is of double-walled design and forms an interstice 52, 62, which can be used both for cooling and for heating by means of supplied and removed coolant or heating medium. In this case, the interstice 52, 62 extends substantially over the entire circumference of the cylindrical housing 41 and over almost the entire height of the wall 48 of the housing 41. Via a feed 54, 64 for coolant or heating medium in the lower region of the housing 41 in the wall 48, the coolant is fed to the interstice 52, 62 and discharged via the discharge line 55, 65 for coolant or heating medium in the upper region of the housing 41 in the wall 48.

The housing 41 of the vacuum separator 40 is held by a stand 47 in an upright, and in particular vertical, orientation.

The insert 49 in the housing 41 of the vacuum separator 40 has a cover 46, from which a plurality of cooling pipes 51 project downwards. These cooling pipes 51 are designed as double-walled cooling pipes 51, such that the inner pipe ends in the outer pipe in front of the lower end of the outer pipe, and the lower end of the outer pipe is designed so as to be closed such that a connection space is formed between the interior of the inner pipe and the interstice between the inner and outer pipes. As a result, a coolant fed to the inner pipe can be guided downwards via the inner pipe, deflected in the connection space, and guided upwards again via the interstice between the inner and outer pipes. It is also possible to guide the coolant in the opposite direction through the double-walled cooling pipes 51.

The cooling pipes 51 are arranged in parallel to one another. The cover 46 is connected to a feed 54 for coolant and enables the coolant to be supplied to the inner pipes of the double-walled cooling pipes 51 via channels arranged in the interior of the cover 46.

The double-walled cooling pipes 51 and the feed 54 for coolant and the discharge line 55 for coolant are part of the cooling arrangement 50 and can alternatively be used as part of the heating arrangement 60, and thus form double-walled heating pipes 61 and the feed 64 for heating medium and the discharge line 65 for heating medium. They thus represent common double-walled pipes 51, 61 and common feeds 54, 64, as well as common discharge lines 55, 65.

The cover 46 is connected to a discharge line 55 for coolant and enables a discharge of the coolant from the interstices between the inner and outer pipes of the double-walled cooling pipes 51 via channels arranged in the interior of the cover 46.

The double-walled pipes 51, 61 belong, with the interstice 52, 62, to the cooling arrangement 50 or to the heating arrangement 60, and thus enable a very efficient cooling effect or heating effect in the vacuum separator 40.

Furthermore, the insert 49 has nine scrapers 71, which are part of the mechanical purifying device 70 and can be displaced along the double-walled cooling pipes by means of a drive rod 73, which extends downwards in parallel with the double-walled cooling pipes 51 through the cover 46. The drive rod 73 is driven by means of a drive 72 of the mechanical purifying device 70 above the cover 46, and is thereby moved displaceably. The drive 72 is designed as an electric drive.

The scrapers 71 have substantially the shape of a semi-oval plate and are fixedly connected to the drive rod 73. In this case, the scrapers 71 are oriented obliquely to the drive rod 73 or to the double-walled pipes 51, 61, so that they are arranged in a V-shaped manner, offset to one another, over the length of the drive rod 73.

The scrapers 71 have at least as many recesses as double-walled pipes 51, 61, and are designed and arranged such that their edge is suitable for scraping deposits on the surface of the double-walled pipes 51, 61. In addition, the outer contour of the scrapers 71 is designed such that it is suitable for scraping off the inner wall of the wall 48 of the housing 41 of the vacuum separator 40 according to the surface of the double-walled pipes 51, 61 when the insert 49 is inserted into the housing 41 and is fixedly connected thereto. The double-walled pipes 51, 61 and the purifying device 70 project with the scrapers 71 and the drive rod 73 into the interior 45 of the housing 41. The double-walled pipes 51, 61 in the interior 45 extend almost to the lower end, and thus to the bottom of the housing 41. The removal opening 44 designed as a suction opening is arranged in the base.

The gas inlet 42 in the wall 48 is arranged below the gas outlet 43 in the housing 41, as a result of which an upward gas flow of the gas to be purified is produced in the interior 45 of the housing 41 and thereby moves along the cooling arrangement 50. In this case, the gas inlet 42 is arranged in such a way that the gas which is flowing into the interior 45 of the housing 41 and is to be purified impinges in a targeted manner on the cooling arrangement 50 in the region of the lower end of the double-walled cooling pipes 51 and is subsequently guided upwards in the direction of the gas outlet 43 along the cooling pipes 51 and the interstice 52 for coolant. This design makes it possible to achieve an efficient cooling of the gas to be purified with the aid of the cooling arrangement 50.

In this case, silicone oil or a brine solution based upon water has proven particularly useful as a heating medium or as a coolant, since they allow, on the one hand, low temperatures of the coolant in the range of minus 20° C. and, on the other, high temperatures of the heating medium in the range of 100° C. to 160° C.

### LIST OF REFERENCE SIGNS

1 device for the purification of gases
2 vacuum zone
3 vacuum or degassing line
40 vacuum separator
41 vacuum separator housing
42 gas inlet
43 gas outlet
44 removal opening
45 interior of the housing
46 cover
47 vacuum separator stand
48 wall of the housing
49 insert
50 cooling arrangement
51 cooling pipe
52 interstice for cooling
53 cooling unit
54 feed for coolant
55 discharge line for coolant
60 heating arrangement
61 heating pipe
62 interstice for heating
63 heating unit
64 feed for heating medium
65 discharge line for heating medium
70 mechanical purifying device
71 scraper
72 drive of the mechanical purifying device
73 drive rod
8 auxiliary filter
9 switching valve for gas to be purified
10 switching valve for heating medium or coolant
11 central discharge of the purified gas
12 sensors

1. Method for purifying gases from the degassing of polymer melts—in particular, for continuous further processing to form stretched polymer films—having the following features:
from a vacuum zone of a plasticizing unit, the gas to be purified is fed, via at least one vacuum or degassing line, to a vacuum separator with a gas inlet and a gas outlet,
in which condensible, separable by freezing, and/or re-sublimable substances from the fed and purified gas are separated by means of a cooling arrangement, and the separated substances are removed from the vacuum separator,
wherein
the separation of the substances from the gas to be purified in the vacuum separator takes place by means of freezing-out by cooling the substances to be separated by means of the cooling arrangement,
the substances separated by means of the cooling arrangement are at least partially liquefied or softened by means of a heating arrangement and are removed from the vacuum separator,
and in that, by means of a mechanical purifying device—in particular, with at least one scraper—the substances separated on the cooling arrangement are superficially scraped off at least partially.

2. Method for the purification of gases from the degassing of polymer melts according to claim 1, wherein the separation of the substances from the gas to be purified in the vacuum separator occurs by means of freezing-out by cooling to a temperature below the triple point of the substances to be separated—in particular, in the range of minus 18° C. or below.

3. Method for the purification of gases from the degassing of polymer melts according to claim 1, wherein the freezing-out of the substances from the gas to be purified in the vacuum separator takes place at a negative pressure of below 100 mbar or below 10 mbar.

4. Method for the purification of gases from the degassing of polymer melts according to claim 1, wherein the substances separated by means of the cooling arrangement are heated to a temperature in the range of the liquefaction or softening temperature of at least part of the separated substances, wherein the heating takes place in particular to a temperature in the range of 100° C. or above.

5. Device for the purification of gases from the degassing of polymer melts, wherein the gas to be purified is fed from a vacuum zone of a plasticizing unit to the device by means of at least one vacuum or degassing line,
with a vacuum separator,
which has a housing having a gas inlet for the gas to be purified and a gas outlet,
having a cooling arrangement, by means of which condensible, separable by freezing, and/or re-sublimable substances can be separated from the supplied gas to be purified,
and from which the separated substances can be removed from the housing of the vacuum separator,
wherein,
the cooling arrangement is designed so that the separation of the substances from the gas to be purified in the vacuum separator occurs by freezing-out the substances to be separated,
the vacuum separator is provided with a heating arrangement which is suitable for at least partially liquefying or softening substances separated by means of the cooling arrangement,
it further has a mechanical purifying device—in particular, with at least one scraper—for at least partial surface scraping of the cooling arrangement,
and in that a removal opening is provided in the lower region of the housing of the vacuum separator, via which removal opening the substances to be at least partially liquefied or softened can be removed.

6. Device for the purification of gases according to claim 5, wherein the cooling arrangement is designed to cool the gas to be purified in such a way that the freezing-out is effected by cooling to a temperature below the triple point of the substances to be separated—in particular, at a temperature in the range of minus 18° C. or below.

7. Device for the purification of gases according to claim 5, wherein the freezing-out takes place at a negative pressure of below 100 mbar, and in particular below 10 mbar.

8. Device for the purification of gases according to claim 5, wherein the heating arrangement is designed to heat the substances separated by means of the cooling arrangement to a temperature in the range of the liquefaction or softening temperature of at least part of the separated substances, wherein the heating occurs in particular to a temperature in the range of 100° C. or above.

9. Device for the purification of gases according to claim 5, wherein the heating arrangement has at least one heating pipe extending into the interior of the housing of the vacuum separator, which heating pipe is designed in particular as a double-walled heating pipe for receiving a heating medium,
wherein in particular several heating pipes and/or inner and outer pipes of one or more double-walled heating pipes are interconnected in a meandering manner.

10. Device for the purification of gases according to claim 9, wherein the housing of the vacuum separator has a cover which forms a feed and/or discharge line for heating medium to several heating pipes extending in particular in parallel and/or formed as a double pipe.

11. Device for the purification of gases according to claim 5,
wherein the heating arrangement is arranged at least partially in the wall of the housing and has at least one heating pipe extending in the wall of the housing and/or at least one or more heating pipes connected to one another in a meandering manner and/or one or more interstices extending in a planar way over the wall of the housing for receiving a heating medium.

12. Device for the purification of gases according to claim 5,
wherein the cooling arrangement and the heating arrangement of the vacuum separator have at least one common pipe and/or at least one interstice for receiving a heating medium and a coolant, wherein in particular at least one switching valve is connected upstream and downstream of the at least one common pipe and/or interstice, so that a selective application of heating medium or coolant to the common pipes and/or interstices is possible.

13. Device (1) for the purification of gases according to claim 5,
wherein the vacuum separator has a solvent feed by means of which a solvent for the separated substances can be fed to the housing in such a way that the supplied solvent impinges on the cooling arrangement and is suitable for at least partially dissolving substances separated thereon, so that the at least partially dissolved substances can be removed from the housing of the vacuum separator via the removal opening.

14. Device for the purification of gases according to claim 5,
wherein the mechanical purifying device—in particular, the at least one scraper—is designed as part of the heating arrangement.

15. Device for the purification of gases according to claim 5, wherein the mechanical purifying device is provided with at least one scraper which is oriented obliquely to a vertical of the vacuum separator and is suitable for purifying the surface of the cooling arrangement with the substances separated thereon and scraping off said substances.

16. Device for the purification of gases according to claim 5,
further having at least one auxiliary filter arranged downstream in the gas flow and suitable for filtering out non-separated substances in the gas to be purified.

17. Device for the purification of gases according to claim 5, wherein several vacuum separators are provided, which are arranged upstream and downstream of at least one switching valve and which in particular are associated with further auxiliary filters, so that an alternative operation of individual vacuum separators and/or auxiliary filters is made possible.

18. Device for the purification of gases according to claim 5, having a controller which is connected to several sensors for detecting operating parameters of the device—in particular, the temperature, pressure, time, volume, or mass—and to several actuators for controlling the device—in particular, for controlling the gas flow, the heating arrangement, the cooling arrangement, the vacuum arrangement, and/or the purifying arrangement.
